(19) United States
(12) Patent Application Publication
(10) Pub. No.: US 2025/0074681 A1
(43) Pub. Date: Mar. 6, 2025

(54) CONTAINER AND PACKAGING SYSTEM

(71) Applicant: RING CONTAINER TECHNOLOGIES, LLC, Oakland, TN (US)

(72) Inventors: CARL D. RING, Memphis, TN (US); Douglas Miles Dygert, Olive Branch, MS (US); Trevell A. Terry, Southaven, MS (US); Paul Vincent Kelley, Arlington, TN (US)

(73) Assignee: RING CONTAINER TECHNOLOGIES, LLC, Oakland, TN (US)

(21) Appl. No.: 18/459,915

(22) Filed: Sep. 1, 2023

(51) Int. Cl. B65D 77/04; B65D 1/02

(52) U.S. Cl. CPC B65D 77/0426; B65D 1/0207; B65D 1/0246; B65D 2501/0018; B65D 2501/0081

(57) ABSTRACT

A method for manufacturing packaging comprises the steps of: temperature conditioning one or more selected portions of at least one preform; and blowing and/or stretching the at least one temperature conditioned preform into a blow mold to form a container including an offset neck finish. Containers, packaging systems and packaging products are disclosed.

### TECHNICAL FIELD

The present disclosure generally relates to a container and package system for food packaging, and methods for making the same.

### BACKGROUND

Food packaging containers can be used with a variety of products. In some cases, such containers are blow molded from suitable plastic resins in a range of shapes and sizes. The empty blow-molded containers can be filled with food, food preparation and/or beverage products at a fill site utilizing automated fill equipment. These food packaging containers, however, can be difficult in handling, for example, to carry and dispense the food, food preparation and/or beverage products.

In some cases, a packaging system includes the food packaging container and an external box, which houses the container and facilitates handling. The box can provide strength and/or protection. The box can also provide packaging for stacking and transport, as well as a surface for advertising and labeling materials relating to the product contained therein. This disclosure describes an improvement over these prior technologies.

### SUMMARY

In one embodiment, a method for manufacturing packaging is provided. The method for manufacturing packaging comprises the steps of: temperature conditioning one or more selected portions of at least one preform; and blowing and/or stretching the at least one temperature conditioned preform into a blow mold to form a container including an offset neck finish. In some embodiments, containers, packaging systems and packaging products are disclosed.

In one embodiment, the method for manufacturing packaging comprises the steps of: injecting resin into a mold to form a preform; temperature conditioning the preform including applying a greater amount of heating to a first selected portion of the preform and applying a lesser amount of heating and/or cooling to a second selected portion of the preform; blowing and/or stretching the temperature conditioned preform into a blow mold to form a container including an offset neck finish; releasing the container from the blow mold; and transferring the container along a manufacturing line for disposal with a box.

In one embodiment, a packaging is provided. The packaging includes a container. The container includes a handle-less top wall having an offset neck finish defining an opening in communication with an interior of the container, a bottom wall, and a plurality of sidewalls extending between the top wall and the bottom wall. A box comprises a top cover, a bottom cover and connected sidewalls defining an inner cavity configured for disposal of the container.

### BRIEF DESCRIPTION OF THE DRAWINGS

The present disclosure will become more readily apparent from the specific description accompanied by the following drawings, in which:

FIG. 1 is a perspective view of components of one embodiment of packaging in accordance with the principles of the present disclosure;

FIG. 2 is a perspective view of components of one embodiment of packaging in accordance with the principles of the present disclosure;

FIG. 3 is a side view of components of the packaging shown in FIG. 2;

FIG. 4 is a top view of components of the packaging shown in FIG. 2;

FIG. 5 is a front view of the components shown in FIG. 1;

FIG. 6 is a side view of the components shown in FIG. 5;

FIG. 7 is a top view of the components shown in FIG. 5;

FIG. 8 is a bottom view of the components shown in FIG. 5;

FIG. 9 is a break away cross section view of components of one embodiment of a container in accordance with the principles of the present disclosure;

FIG. 10 is a schematic view of one embodiment of a method of manufacturing components of packaging in accordance with the principles of the present disclosure;

FIG. 11 is a schematic view of one embodiment of a method of manufacturing components of packaging in accordance with the principles of the present disclosure;

FIG. 12 is a perspective view of components of one embodiment of packaging in accordance with the principles of the present disclosure;

FIG. 13 is a perspective view of components of one embodiment of packaging in accordance with the principles of the present disclosure;

FIG. 14 is a side view of the components shown in FIG. 13;

FIG. 15 is a top view of the components shown in FIG. 13;

FIG. 16 is a front view of the components shown in FIG. 12;

FIG. 17 is a side view of the components shown in FIG. 12;

FIG. 18 is a top view of the components shown in FIG. 12; and

FIG. 19 is a bottom view of the components shown in FIG. 12.

### DETAILED DESCRIPTION

The exemplary embodiments of a packaging system, method of manufacture and related methods of use disclosed are discussed in terms of packaging systems and more particularly, includes a container and a box for food, food preparation and/or beverage products. In some embodiments, the box encases the container. In some embodiments, the container can be filled with liquids, food, food preparation and/or beverage products. In some embodiments, the container may be made of plastic, for example, polyethylene terephthalate (PET), which can be blow molded into various configurations. In some embodiments, the container can be employed as a cold fill container. In some embodiments, the container can be employed as a hot fill container. In some embodiments, the container includes a large plastic container for edible oil packaging. In some embodiments, the box is configured to facilitate stacking and carrying of the container.

In some embodiments, the present disclosure includes a packaging having a container and a box. In some embodiments, the packaging is configured to deliver, for example, liquids, foods, food preparation and/or beverage products with a container, for example, a bottle supported within a corrugated box. In some embodiments, the packaging is configured to dispense liquids, foods, food preparation and/or beverage products from the container while enclosed in the box. In some embodiments, the packaging is configured to dispense liquids, foods, food preparation and/or beverage products from a neck finish of the container, the neck finish being offset to one side of the container. This configuration facilitates dispensing liquids, foods, food preparation and/or beverage products from the container, for example, without dribbling, running, dripping or spilling, for example, on surfaces of the box such as an inner surface of the box. In some embodiments, the container of the packaging has a reduced weight because of the support the box provides. In some embodiments, the packaging is configured to dispense a large quantity of edible oil, for example, 2.5 gallons or more. In some embodiments, the packaging includes a container having four sidewalls. In some embodiments, the sidewalls define side corners. In some embodiments, each of the side corners include a top corner.

In some embodiments, the present packaging has a container that avoids leaking with improved manufacturing methods, as described herein. In some embodiments, the packaging has a container with improved oxygen barrier properties.

In some embodiments, the present packaging includes a container formed by a manufacturing method that produces an off-center neck such that the container has a selected balance of material distribution in the container side walls.

In some embodiments, the present packaging has a container including a neck finish shifted off-center and toward one side wall. In some embodiments, this configuration of the container facilitates pouring contents of the container and prevents dribbling, running, dripping or spilling of the poured contents onto the top and side surfaces of the container. In some embodiments, this configuration of the container allows dispensing the contents from the container while the container is in the box, which allows for a plastic reduction in manufacturing of the container due to improved structural integrity provided from the box that supports the container.

In some embodiments, the present disclosure includes a container formed by a manufacturing method including the step of selectively heating a preform and placing the preform in a blow mold. In some embodiments, the method of manufacturing produces a container including at least one rectangular PET bottle having a 2 to 1 or greater depth to width ratio. In some embodiments, the method of manufacturing includes the step of selectively heating a preform such that the preform is selectively heated, in a greater or lesser amount, in selected areas of the preform, for example, increased heating in areas of the preform that are desirably stretched more than other areas of the container, for example, in areas disposed 90 degrees relative thereto and/or in opposing relation. In some embodiments, the method of manufacturing provides a container configuration having plastic material evenly distributed throughout the side walls of the container. In some embodiments, the method of manufacturing includes the step of selectively heating a preform to produce a container with an offset neck such that the preform is selectively heated on one side of the preform before the preform is inserted into the blow mold. In some embodiments, this configuration allows the material to stretch a greater amount on a side opposite the neck area of the container.

In some embodiments, the present packaging has a container including a PET bottle contained within a corrugated box. In some embodiments, the box has a top opening and a front opening. In some embodiments, the container includes a central axis and a neck finish offset from the central axis a distance selected from a range of 0.25 through 3.00 inches toward the front side of the container.

In some embodiments, the present packaging has a container including a PET bottle having a top wall, a bottom wall opposite the top wall, a side extending from the top wall to the bottom wall and a neck extending upward from the top wall such that the neck is offset from a center of the top wall. In some embodiments, the neck is offset at least 1 inch from a center of the top wall. In some embodiments, the neck is offset a distance selected from a range of 1.00 through 2.00 inches from a center of the top wall.

In some embodiments, the present disclosure includes a method of manufacturing a PET container employing a single stage, stretch injection blow molding process, which includes one or more positions, for example, stations and/or treatments in a single machine. In some embodiments, the single stage method comprises the step of injecting PET resin into a mold to form a preform in a first position. In some embodiments, the single stage method comprises the step of temperature conditioning the preform, for example, heating or cooling the preform in a second position for selectively blowing container side wall thickness. In some embodiments, the step of temperature conditioning the preform allows the region of the wall of the preform closest to the bottle sidewall to be hotter than the region of the preform sidewall of the bottle side wall that is further away from the bottle sidewall. For example, heating a closer sidewall region of the preform more or cooling a distant sidewall. In some embodiments, the single stage method comprises the step of blowing the preform into a blow mold to form the container in a third position. In some embodiments, the single stage method comprises the step of constructing a box. In some embodiments, the single stage method comprises the step of releasing the container from the mold and transferring the container along a manufacturing line for disposal with a box. In some embodiments, the single stage method comprises the step of palletizing one or more containers in a box for transfer to a filling line. In some embodiments, the single stage method comprises the step of directly filling one or more containers in a box.

In some embodiments, the present disclosure includes a method of manufacturing a PET container employing a two stage, stretch injection blow molding process, which includes one or more positions, for example, stations and/or treatments in two machines. In some embodiments, the two stage method comprises the step of injecting PET resin into a mold to form a preform in a first position. In some embodiments, the two stage method comprises the step of cooling the preform and transferring the preform to a position, for example, a storage bin. In some embodiments, the preforms are transferred from the storage bin to a second position for temperature conditioning, for example, heating and/or cooling. In some embodiments, the two stage method comprises the step of heating and/or reheating the preform to a temperature profile of 90-110 degrees Celsius (C) to adjust a temperature profile of the preform side wall to selectively blow bottle wall thickness. In some embodiments, the step of temperature conditioning the preform allows the region of the wall of the preform closest to the bottle sidewall to be hotter than the region of the preform sidewall of the bottle side wall that is further away from the sidewall. For example, heating a closer sidewall region of the preform more or cooling a distant sidewall. In some embodiments, the two stage method comprises the step of blowing and/or stretching the preform into a blow mold to form the container. In some embodiments, the two stage method comprises the step of positioning the preform in the blow mold and adjusting the preform position with the mold so that the centerline of the container is at an angle of 10 or more degrees relative to a vertical axis of the preform. In some embodiments, the two stage method comprises the step of releasing the container from the mold and transferring the container along a manufacturing line for disposal with a box. In some embodiments, the two stage method comprises the step of releasing the container from the mold and transferring the container along a manufacturing line for disposal with a box. In some embodiments, the two stage method comprises the step of constructing a box. In some embodiments, the two stage method comprises the step of palletizing one or more containers in a box for transfer to a filling line. In some embodiments, the two stage method comprises the step of directly filling one or more containers in a box.

In some embodiments, the present disclosure includes a method of manufacturing a PET bottle comprising the steps of providing a preform; heating only one side of the preform; and blow molding the preform to form a bottle such that the neck of the bottle is offset from a center of a top of the bottle. In some embodiments, the neck is offset at least 1 inch from a center of the top wall. In some embodiments, the method of manufacturing produces a bottle having a neck offset at least 1 inch. In some embodiments, the method of manufacturing produces a bottle having a neck offset a distance selected from a range of 1.00 through 2.00 inches from a center of the top wall.

In some embodiments, the container includes blow-molded plastic jugs or bottles. In some embodiments, the container includes a 35 pound or a 5 gallon jug. In some embodiments, the container is manufactured via an injection molded preform, which is subjected to a blow mold process. In some embodiments, the container is manufactured and subjected to a trimming process.

In some embodiments, the present disclosure may be useful for manufacturers that run multiple sizes of blow and trim bottles for various end uses. For example, the present disclosure may be useful to produce containers for food items, for example, oils, dressings and sauces. In some embodiments, the present disclosure may be useful to produce containers for food items that require color pigment for both fill-line concealment and product protection against UV light penetration. Other containers that can be made from the disclosed process include containers for mayonnaise, salad dressings, as well as other condiments and/or food products.

In some embodiments, the present container may be formed by manufacturing methods that provide PET enhancements via improved material orientation with selective physical performance features, for example, improved top load performance, improved vacuum resistance performance and/or hoop strength, improved O₂ performance, improved moisture vapor transmission rate (MVTR) performance. In some embodiments, the enhancements include modifications to the manufacturing process or the addition of additives to provide a container made of PET that has a selected crystallinity, as discussed herein.

In some embodiments, the manufacturing methods are configured to produce a container that has a crystallinity of about 10%. In some embodiments, the method is configured to produce a container that has a crystallinity between about 15% and about 20%. In some embodiments, a preform is heated and stretched to produce a container having a crystallinity between about 18% and about 30%. In some embodiments, the preform is heated and stretched to produce a container having a crystallinity between about 20% and about 40%. In some embodiments, the preform includes a molecular weight between about 120,000 g/mol and about 240,000 g/mol. In some embodiments, the preform includes a molecular weight between about 250,000 g/mol and about 450,000 g/mol. In some embodiments, the preform comprises PET and has an axial stretch ratio of about 1.8 to 1 to about 2.4 to 1.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. Also, in some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

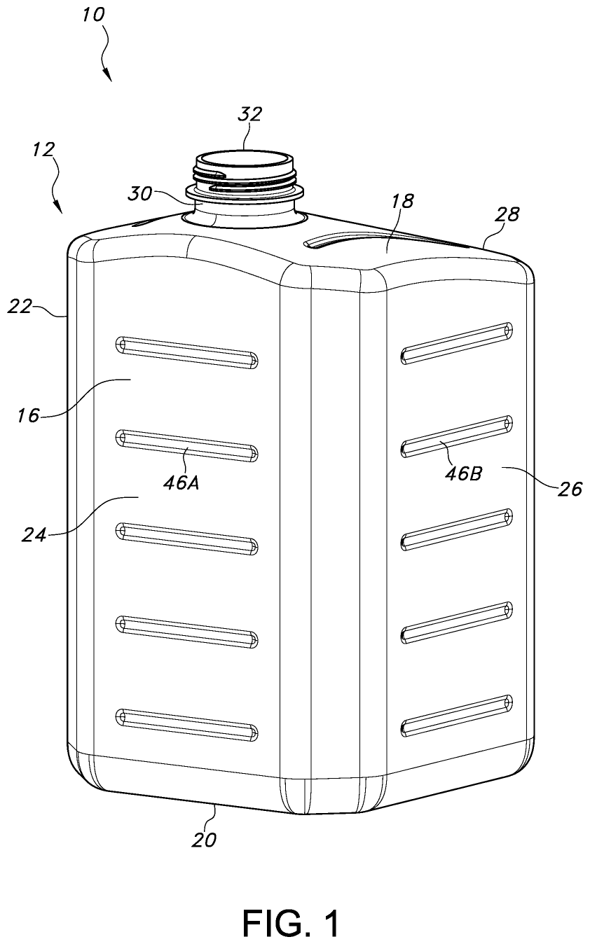

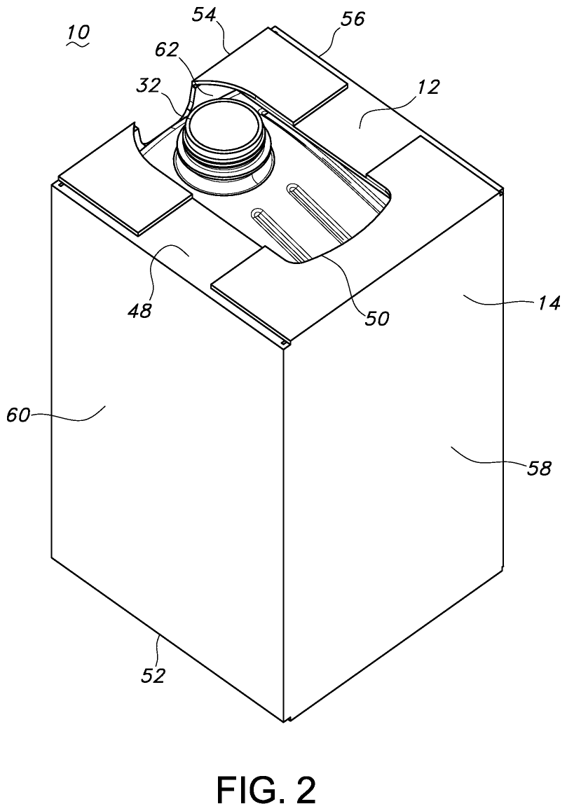

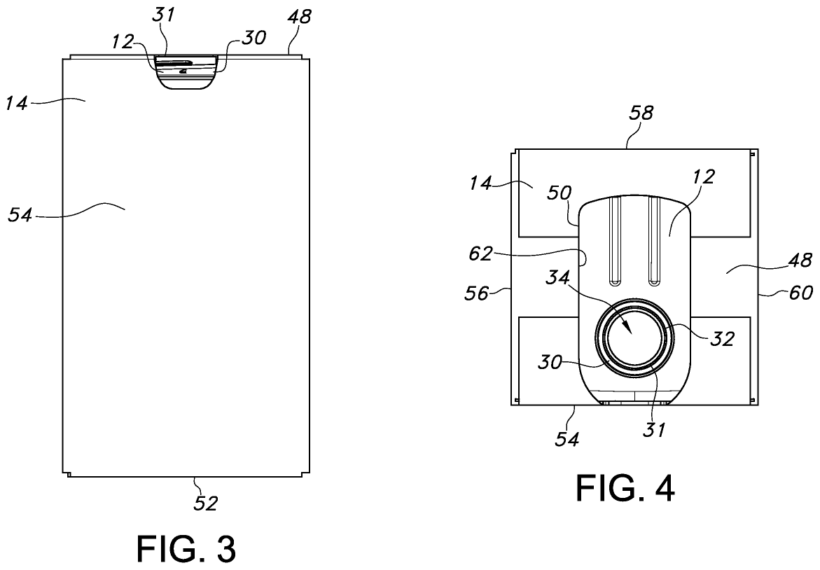

The following discussion includes a description of components of a packaging system and methods of manufacture. Alternate embodiments are also disclosed. Reference is made in detail to the exemplary embodiments of the present disclosure, which are illustrated in the accompanying figures. Turning to FIGS. 1-8, there are illustrated components of a packaging system 10. Packaging system 10 includes a container 12 disposed in a box 14, as shown in FIGS. 1 and 2. In some embodiments, container 12 includes a PET bottle and box 14 includes a corrugated box.

Container 12 is configured to store and/or deliver, for example, liquids, food, food preparation and/or beverage products. In some embodiments, food preparation products include food, food preparation oils, and/or viscous products. In some embodiments, container 12 may include any size and/or shape and may be filled with any type of food and/or beverage. In some embodiments, container 12 is configured to dispense edible oil. In some embodiments, container 12 is configured for use in automotive applications, for example, oils and lubricants.

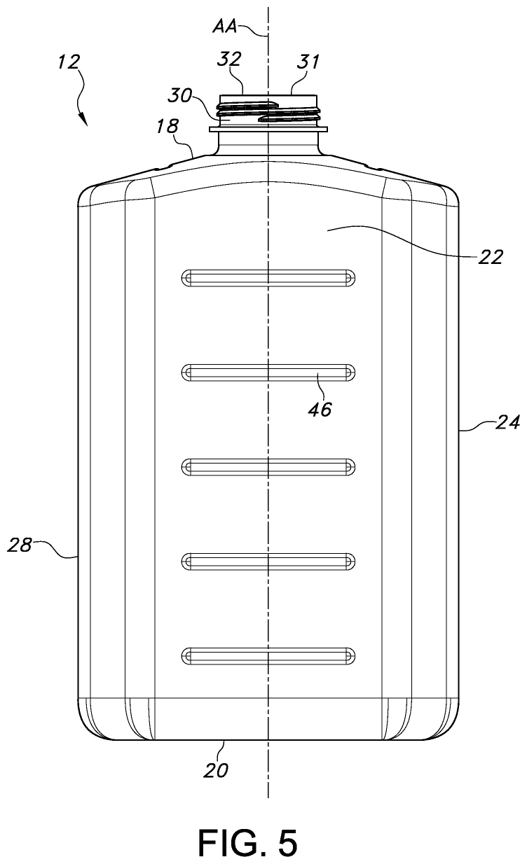

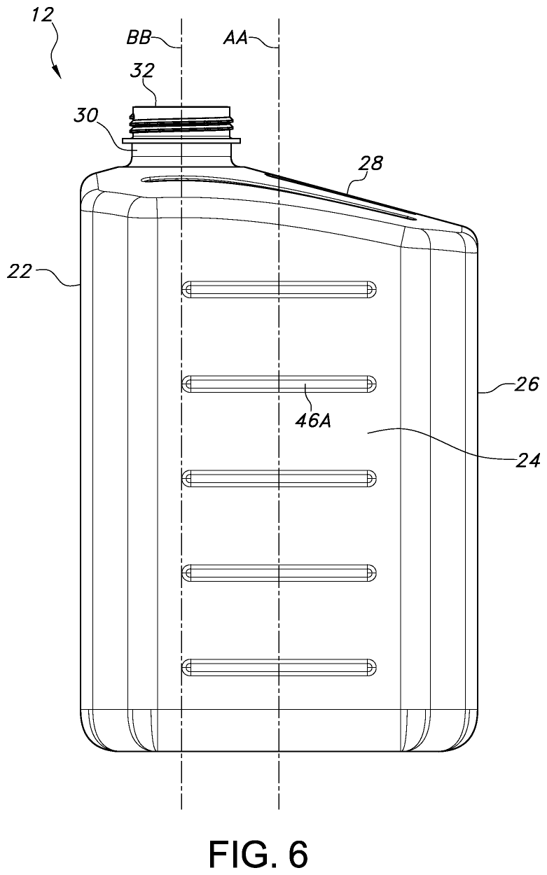

Container 12 includes a body 16 having a top wall 18 and a bottom wall 20. Body 16 includes a plurality of sidewalls 22, 24, 26, 28 that each extend from wall 18 to wall 20. Container 12 and/or body 16 extend along a longitudinal axis AA centrally disposed between wall 18 and wall 20, as shown in FIGS. 5 and 6. Body 16 includes a substantially rectangular cross section. In some embodiments, body 16 includes a substantially square cross section. In some embodiments, body 16 may have various alternative cross section configurations, for example, circular, oval, oblong, triangular, polygonal, irregular, uniform, non-uniform, variable, tubular and/or tapered.

Wall 18 includes a neck finish 30. Neck finish 30 is offset relative to centrally disposed longitudinal axis AA, as shown in FIG. 6. In some embodiments, neck finish 30 is offset or off-center relative to longitudinal axis AA such that container 12 has a selected balance of material distribution in side walls 22, 24, 26, 28. In some embodiments, the distance is selected from a range of 0.25 through 3.00 inches and is adjacent a front side or wall of container 12, for example, wall 22. Neck finish 30 is offset to one side of container 12 to facilitate pouring contents of container 12 and prevents dribbling, running, dripping or spilling of the poured contents onto one or more surfaces of container 12 and/or box 14, as described herein. In some embodiments, the configuration of container 12 allows dispensing the contents from container 12 while container 12 is in box 14, which allows for a plastic reduction in manufacturing of container 12 due to improved structural integrity provided from box 14 that supports container 12. In some embodiments, during manufacture, a preform 102 is selectively heated, for example, on a first side of preform 102 prior to preform 102 being inserted into a blow mold such that the material of preform 102 stretches a greater amount on a second side opposite the neck finish 30 of container 12.

Neck finish 30 includes a spout 31 that defines an opening 32 in communication with an interior 34 of container 12, as shown in FIG. 4. Opening 32 extends along a longitudinal axis BB, that is substantially parallel relative to longitudinal axis AA, as shown in FIG. 6. Longitudinal axis BB is offset a selected distance relative to longitudinal axis AA. In some embodiments, longitudinal axis BB is offset a selected distance from 1 mm to about 4 inches relative to longitudinal axis AA. In some embodiments, opening 32 may have various cross section configurations, for example, circular, oval, oblong, triangular, rectangular, square, polygonal, irregular, uniform, non-uniform, variable, tubular and/or tapered. In some embodiments, opening 32 and/or axis BB may be disposed at alternate orientations, relative to longitudinal axis AA, for example, transverse, parallel and/or other angular orientations such as, oblique, acute or obtuse and/or may be offset or staggered. In some embodiments, interior 34 defines a volume of at least about 2.50 gallons. In some embodiments, interior 34 defines a volume from about 2.50 to about 10 gallons.

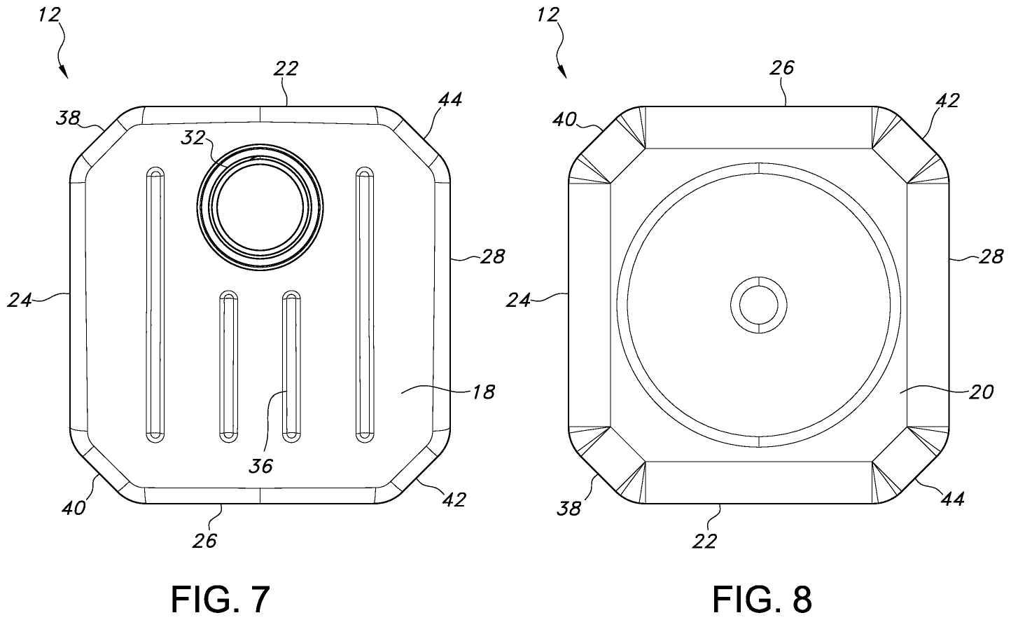

Wall 18 does not include a handle, for example, is handleless. In some embodiments, all or a portion of wall 18 can be smooth, rough, textured, porous, semi-porous, dimpled, knurled, toothed, raised, grooved and/or polished. In some embodiments, wall 18 includes one or more angled or arcuate surfaces. In some embodiments, all or a portion of wall 18 can be textured via a rubber surface. Wall 18 includes a surface that defines a plurality of ribs 36, as shown in FIG. 7. In some embodiments, ribs 36 are strengthening features of container 12. In some embodiments, ribs 36 are aligned with one another perpendicular to longitudinal axis AA. In some embodiments, longitudinal ribs 36 may be disposed at alternate orientations, relative to longitudinal axis AA, for example, transverse, oblique and/or other angular orientations such as acute or obtuse, co-axial and/or may be offset or staggered. In some embodiments, longitudinal ribs 36 each include a linear portion oriented between opposing rounded ends to provide longitudinal ribs 36 with an oblong shape.

Wall 22 opposes wall 26, and wall 24 opposes wall 28. Body 16 is formed such that inner surfaces of walls 22, 24, 26, 28 define interior 34, configured for disposal of liquids, food, food preparation and/or beverage products. In some embodiments, body 16 is manufactured from a single preform, for example, preform 102 that is blow molded to form container 12 such that walls 22, 24, 26, 28 are monolithically and/or integrally formed. In some embodiments, container 12 is made using an extrusion blow molding process.

Wall 18 and/or wall 20 extend perpendicular to axis AA. In some embodiments, wall 18 and/or wall 20 may be disposed at alternate orientations, relative to axis AA and/or axis BB, for example, transverse and/or other angular orientations such as acute or obtuse, co-axial and/or may be offset or staggered. In some embodiments, wall 22, wall 24, wall 26 and/or wall 28 extend parallel to axis AA and/or axis BB. In some embodiments, wall 22, wall 24, wall 26 and/or wall 28 may be disposed at alternate orientations, relative to axis AA and/or axis BB, for example, transverse, oblique and/or other angular orientations such as acute or obtuse and/or may be offset or staggered.

Sidewalls 22, 24 define a side corner 38, as shown in FIGS. 7 and 8. Sidewalls 24, 26 define a side corner 40, sidewalls 26, 28 define a side corner 42 and sidewalls 22, 28 define a side corner 44. Side corners 38, 40, 42, 44 are angled. In some embodiments, side corners 38, 40, 42, 44 are angled from about 20 to about 60 degrees relative to walls 22, 24, 26, 28.

Sidewall 22 includes a plurality of ribs 46 that are perpendicular relative to longitudinal axis AA, as shown in FIG. 5. Sidewall 24 includes a plurality of ribs 46A, similar to ribs 46 and shown in FIG. 1. Sidewall 26 includes a plurality of ribs 46B, similar to ribs 46. Sidewall 28 includes a plurality of ribs (not shown), similar to ribs 46. In some embodiments, one or more of the ribs are configured as gripping surfaces. In some embodiments, one or more of the ribs are strengthening features of container 12. In some embodiments, one or more of the ribs are grooves that each extend into an outer surface of at least one of walls 22, 24, 26 and/or 28. In some embodiments, one or more of the ribs are aligned with one another along longitudinal axis AA such that each of the ribs begin at the same point along longitudinal axis AA and terminate along the same point along longitudinal axis AA. In some embodiments, one or more of the ribs may be disposed at alternate orientations, relative to longitudinal axis AA, for example, transverse, oblique and/or other angular orientations such as acute or obtuse, co-axial and/or may be offset or staggered. In some embodiments, one or more of the ribs include a linear portion oriented between opposing rounded ends to provide an oblong shape.

In some embodiments, all or a portion of walls 22, 24, 26 and/or 28 can be smooth, rough, textured, porous, semi-porous, dimpled, knurled, toothed, raised, grooved and/or polished to facilitate gripping. In some embodiments, all or a portion of walls 22, 24, 26 and/or 28 can be textured via a rubber surface.

Box 14 is configured to facilitate carrying of container 12. See, for example, the packaging systems and methods disclosed in U.S. Pat. No. 7,726,503, the entire contents of which being incorporated by reference herein. In some embodiments, box 14 is configured to facilitate stacking of one or more containers 12 for transport and/or display. Box 14 includes a top cover 48, as shown in FIG. 2. Top cover 48 defines an opening 50 configured to provide access to spout 31 of container 12 such that spout 31 is exposed to facilitate dispensing of material within container 12. Box 14 includes a bottom cover 52. Top cover 48 and bottom cover 52 are connected to sidewalls 54, 56, 58, 60. Sidewalls 54, 56, 58, 60 define an interior cavity 62 configured for disposal of container 12.

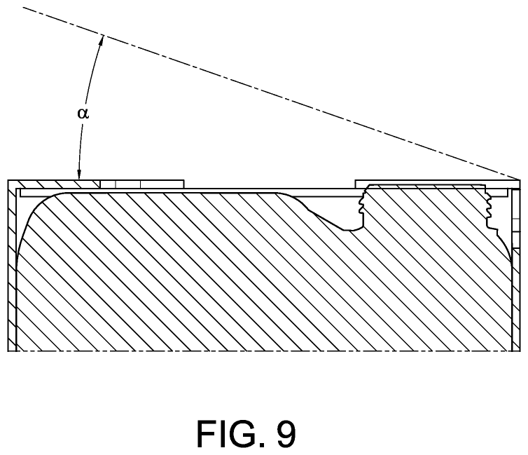

In some embodiments, packaging system 10 defines a discharge, dispensing or pour angle α, as shown in FIG. 9, which corresponds to the position and/or orientation of one or more components of packaging system 10, for example, container 12, spout 31 and/or box 14, relative to a reference as described herein to facilitate discharge, dispensing and/or pouring of the contents of container 12. In some embodiments, the selective positioning and/or orientation of the components of packaging system 10 provides a configuration that facilitates discharge, dispensing and/or pouring the contents from container 12, and prevents dribbling, running, dripping or spilling, for example, on surfaces of box 14 and/or container 12.

In some embodiments, packaging system 10 is disposable between an initial stationary or horizontal position, or orientation and a discharge orientation to facilitate discharge, dispensing and/or pouring the contents from container 12. One or more components of packaging system 10 can define an axis or plane corresponding to a selected surface of one or more components of packaging system 10, for example, top wall 18, opening 32, top cover 48 and/or opening 50, when the components of packaging system 10 are in the initial orientation. Disposal of the selected surface in the initial orientation corresponds to a reference angle α1, for example, an angle α1 of about 0 angular degrees. The components of packaging system 10 are disposed in the discharge orientation, for example, moved, rotated, manipulated and/or handled to an orientation and/or position such that the contents of container 12 are discharged from container 12 and the selected surface is disposed at measured discharge, dispensing and/or pour angle α2, which is measured relative to reference angle α1. In some embodiments, reference angle α1 and/or measured angle α2 can include one or more selected angles, or an angular range. In some embodiments, the components of packaging system 10 are disposed in the discharge orientation such that measured angle α2 includes discharge of the contents of container 12 dribbling, running, dripping or spilling along surfaces of container 12 and/or box 14. In some embodiments, the components of packaging system 10 are disposed in the discharge orientation such that measured angle α2 includes discharge of the contents of container 12 without dribbling, running, dripping or spilling along surfaces of container 12 and/or box 14.

In one example, packaging system 10 includes a container 12, similar that described herein, having a spout/opening that is coaxial, and not offset, relative to longitudinal axis AA, and is disposable between an initial orientation and a discharge orientation to facilitate pouring liquid from container 12, similar to that described herein. In the discharge orientation for this container 12 configuration, relative to reference angle α1, a measured pour angle α2 of 62 degrees discharges the liquid contents of container 12 with dribbling, running, dripping or spilling along surfaces of container 12 and/or box 14. In the discharge orientation for this container 12 configuration, relative to reference angle α1, a measured pour angle α2 of 67 degrees discharges the liquid contents of container 12 without dribbling, running, dripping or spilling along surfaces of container 12 and/or box 14.

In another example, packaging system 10 includes a container 12, similar that described herein, having a spout/opening that defines an axis that is offset a selected distance in a range of 2.400 through 2.500 inches, for example, 2.477 inches, relative to longitudinal axis AA, and is disposable between an initial orientation and a discharge orientation to facilitate pouring liquid from container 12, similar to that described herein. In the discharge orientation for this container 12 configuration, relative to reference angle α1, a measured pour angle α2 of 50 degrees discharges the liquid contents of container 12 without dribbling, running, dripping or spilling along surfaces of container 12 and/or box 14. This configuration facilitates dispensing the contents from container 12 without dribbling, running, dripping or spilling on surfaces of the box to avoid dripping liquid contents onto box corrugate to maintain integrity of the box and provide improved safety. This configuration also facilitates less strain on a user.

In another example, packaging system 10 includes a container 12, similar that described herein, having a spout/opening that defines an axis that is offset a selected distance in a range of 2.250 through 2.400 inches, for example, 2.324 inches, relative to longitudinal axis AA, and is disposable between an initial orientation and a discharge orientation to facilitate pouring liquid from container 12, similar to that described herein. In the discharge orientation for this container 12 configuration, relative to reference angle α1, a measured pour angle α2 of 59 degrees discharges the liquid contents of container 12 without dribbling, running, dripping or spilling along surfaces of container 12 and/or box 14. This configuration facilitates dispensing the contents from container 12 without dribbling, running, dripping or spilling on surfaces of the box to avoid dripping liquid contents onto box corrugate to maintain integrity of the box and provide improved safety. This configuration also facilitates less strain on a user.

In another example, packaging system 10 includes a container 12, similar that described herein, having a spout/opening that defines an axis that is offset a selected distance in a range of 2.900 through 3.200 inches, for example, 3.064 inches, relative to longitudinal axis AA, and is disposable between an initial orientation and a discharge orientation to facilitate pouring liquid from container 12, similar to that described herein. In the discharge orientation for this container 12 configuration, relative to reference angle α1, a measured pour angle α2 of 53 degrees discharges the liquid contents of container 12 without dribbling, running, dripping or spilling along surfaces of container 12 and/or box 14. This configuration facilitates dispensing the contents from container 12 without dribbling, running, dripping or spilling on surfaces of the box to avoid dripping liquid contents onto box corrugate to maintain integrity of the box and provide improved safety. This configuration also facilitates less strain on a user.

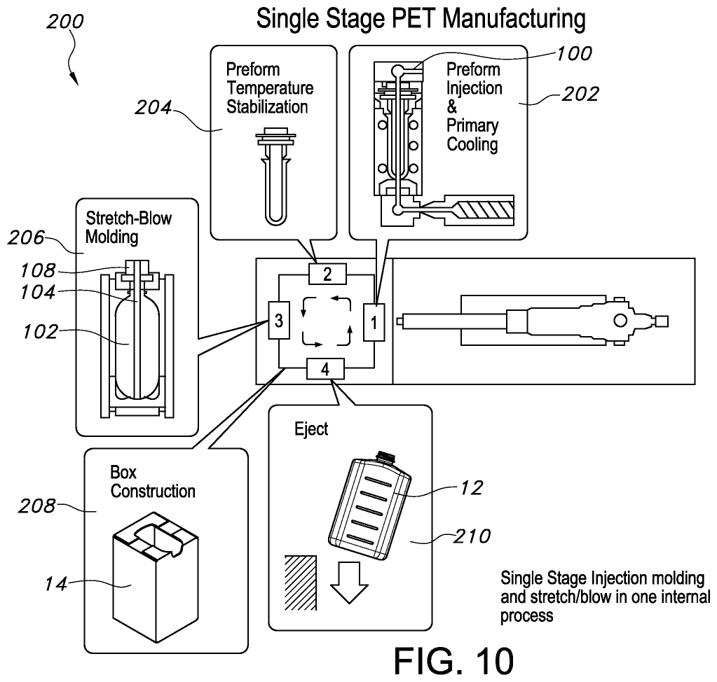

In some embodiments, a method 200 of manufacturing a PET container, for example, container 10 is provided, as shown in FIG. 10. The method employs a single stage, stretch injection blow molding process, which includes one or more positions, for example, stations and/or treatments in a single machine, as described below. The method includes the step 202 of injecting PET resin into a mold 100 to form a preform, for example, preform 102 in a first position. The method includes the step 204 of temperature conditioning preform 102, for example, heating or cooling preform 102 in a second position such that preform 102 is optimized for blowing a container side wall thickness. In some embodiments, the step 204 of temperature conditioning preform 102 allows the region of the wall of preform 102 closest to a first container sidewall to be hotter than the region of preform 102 of a second container side wall that is further away from the first container sidewall, for example, heating a closer sidewall region of preform 102 more, or cooling a distant sidewall.

In some embodiments, the step 204 of temperature conditioning by heating or cooling preform 102 enables heat to be applied to a selected portion of a top wall 104 of preform 102, similar to wall 18 of container 12, so that preform 102 material flows to a portion of preform 102 that corresponds to a portion (not shown) of top wall 104 posterior to a neck finish 108, similar to offset neck finish 30 of container 12, which results in a more uniform wall thickness throughout top wall 104. In some embodiments, cooling can be applied to the portion of top wall 104 posterior to neck finish 108 such that a portion (not shown) of top wall 104 anterior to neck finish 108 is at a higher temperature. In some embodiments, preform 102 material of the portion of top wall 104 anterior to neck finish 108 flows to the portion of preform 102 that corresponds to the portion of wall 104 posterior to neck finish 108 to result in a more uniform wall thickness throughout top wall 104.

The method includes the step 206 of blowing preform 102 into a blow mold to form container 12 in a third position. The method includes the step 208 of constructing a box, for example, box 14. The method includes the step 210 of releasing container 12 from mold 100 and transferring container 12 along a manufacturing line for disposal with box 14. The method includes the step 212 (not shown) of palletizing one or more containers 12 into one or more boxes 14 for transfer to a filling line. The method includes the step 214 (not shown) of directly filling one or more containers 12 into one or more boxes 14.

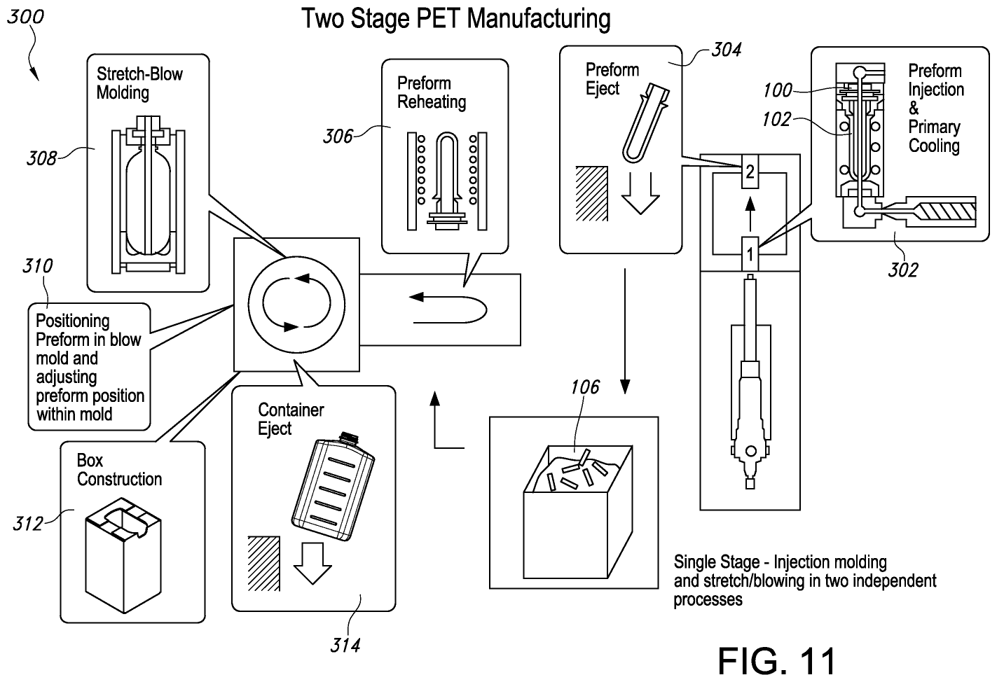

In some embodiments, the present disclosure includes a method 300 of manufacturing a PET container, for example container 10 is provided, as shown in FIG. 11. The method employs a two stage, stretch injection blow molding process, which includes one or more positions, for example, stations and/or treatments in two machines. The method includes the step 302 of injecting PET resin into a mold, for example, mold 100 to form a preform, for example, preform 102 in a first position. The method includes the step 304 of cooling preform 102 and transferring preform 102 to a position, for example, a storage bin 106. In some embodiments, preforms 102 are transferred from storage bin 106 to a second position for temperature conditioning, for example, heating and/or cooling.

The method includes the step 306 of heating and/or reheating preform 102 to a temperature profile of 90-110 C to adjust a temperature profile of preform 102 side wall to blow optimal bottle wall thickness. In some embodiments, the second position of temperature conditioning preform 102 allows the region of the wall of preform 102 closest to the bottle sidewall to be hotter than the region of preform 102 sidewall of the bottle side wall that is further away from the sidewall. For example, heating a closer sidewall region of preform 102 more or cooling a distant sidewall. The method includes the step 308 of blowing and/or stretching preform 102 into a blow mold to form container 12. The method includes the step 310 of positioning preform 102 in the blow mold 100 and adjusting preform 102 position with mold 100 so that the centerline of container 12 is at an angle of 10 or more degrees relative to a vertical axis of preform 102.

The method includes the step 312 of constructing a box 14. The method includes the step 314 of releasing container 12 from mold 100 and transferring container 12 along a manufacturing line for disposal with a box, for example, box 14. In some embodiments, the two stage method further comprises palletizing one or more containers 12 into one or more boxes 14 for transfer to a filling line. In some embodiments, the two stage method further comprises directly filling one or more containers 12 into one or more boxes 14.

In some embodiments, the step (208)/(312) of constructing a box 14, as described above includes, cutting a sheet (not shown) by a die-cutter into a selected configuration of box 14. In some embodiments, a trimmer cuts a design of box 14. In some embodiments, the trimmer includes sharp and rubber blades to allow for forming lines that are scored not cut. A bending machine folds the sheet along scored lines and glue or stitches is applied to form assembled box 14. In some embodiments, container 12 is pre-filled via an automated fill machine. Container 12 is disposed within cavity 62 of box 14. Box 14 is configured to facilitate gripping of container 12 for carrying and/or a selected pouring material.

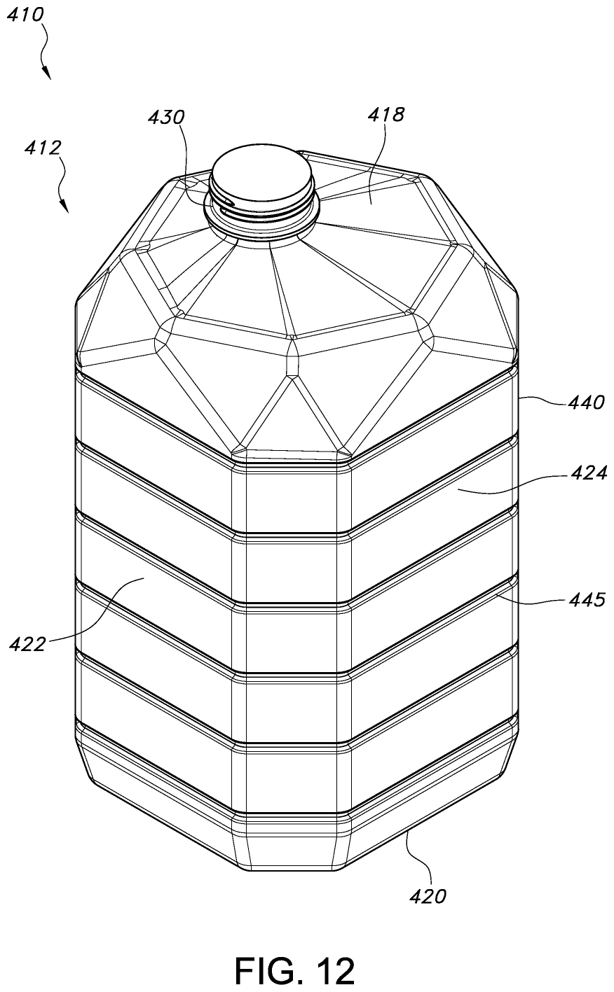

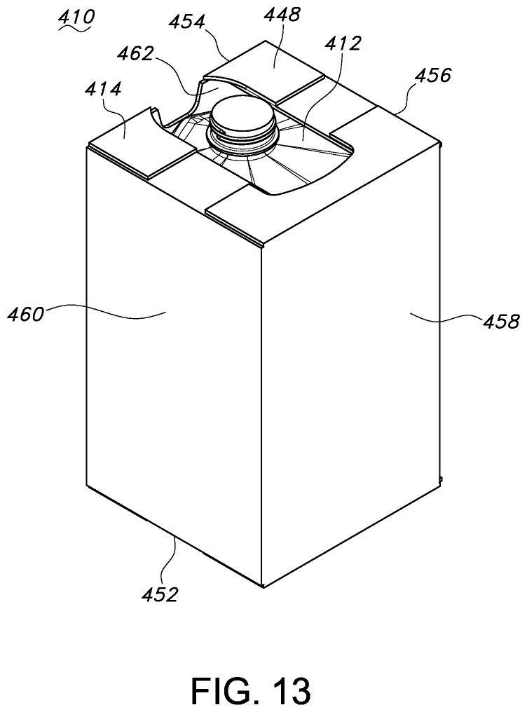

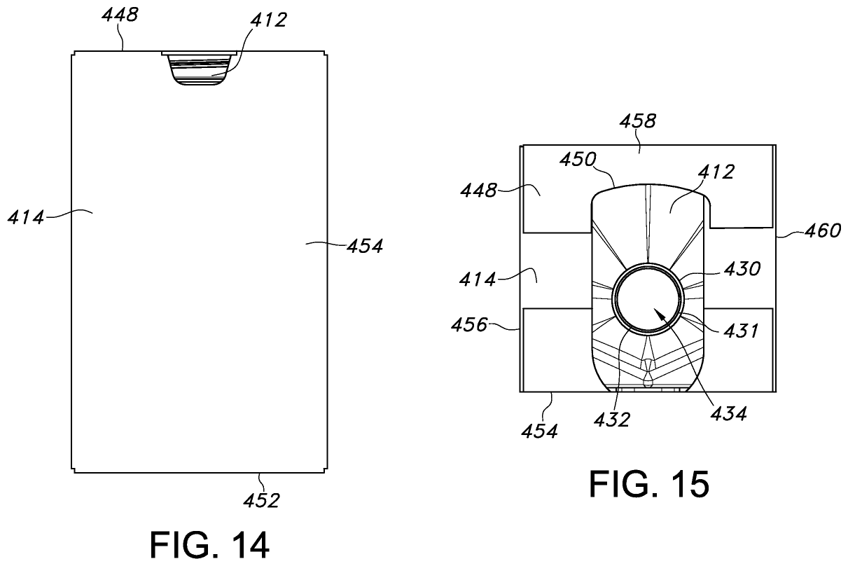

In one embodiment, as shown in FIGS. 12-19, a packaging system 410, similar to packaging system 10, includes a container 412, similar to container 12, that is disposed in a box 414, similar to box 14, as shown in FIG. 13. In some embodiments, container 412 and box 414 are manufactured in a single stage or a two stage manufacturing process similar to container 12 and box 14. In some embodiments, container 412 includes a PET bottle and box 414 includes a corrugated box. Container 412 is configured to store and/or deliver, for example, liquids, food, food preparation and/or beverage products, described herein.

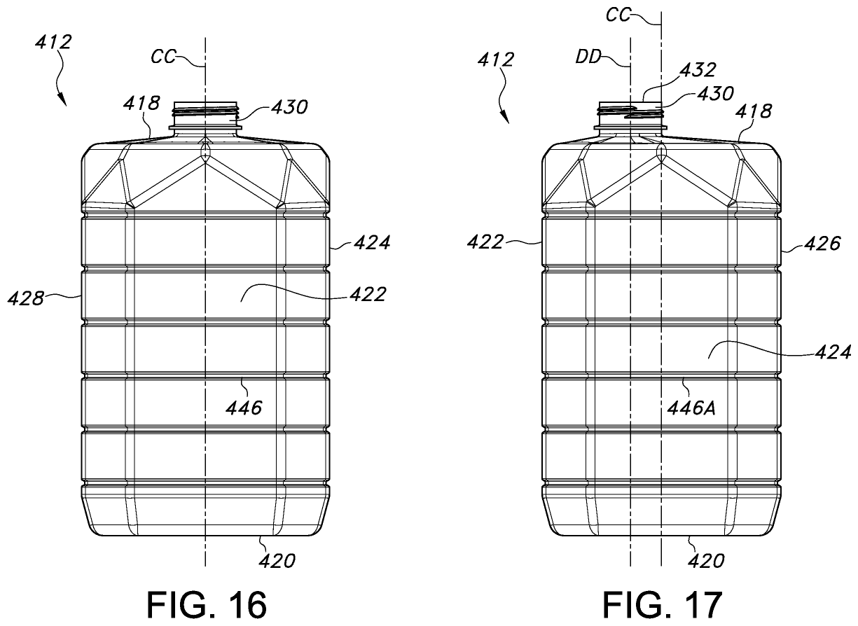

Container 412 includes a body 416 having a top wall 418 and a bottom wall 420. Body 416 includes a plurality of sidewalls 422, 424, 426, 428 that each extend from wall 418 to wall 420. Container 412 and/or body 416 extend along a longitudinal axis CC centrally disposed between wall 418 and wall 420, as shown in FIGS. 16 and 17. Body 416 includes a substantially rectangular cross section.

Wall 418 includes a neck finish 430. Neck finish 430 is offset relative to centrally disposed longitudinal axis CC, as shown in FIG. 17. In some embodiments, neck finish 430 is offset or off-center relative to longitudinal axis CC such that container 412 has a balance of material distribution in container 412 side walls 422, 424, 426, 428. In some embodiments, the distance is selected from a range of 0.25 through 3.00 inches and is adjacent a front side or wall of container 412, for example, wall 422. In some embodiments, the distance that is selected from a range of 1 through 2 inches. In some embodiments, the distance that is selected is at least 1 inch. Neck finish 430 is offset to one side of container 412 to facilitate pouring contents of container 412 and prevents dribbling, running, dripping or spilling of the poured contents onto the top, for example, wall 418, or sides 422, 424, 426 and/or 428 of container 412, as described herein.

Neck finish 430 includes a spout 431 that defines an opening 432 in communication with an interior 434 of container 412, as shown in FIG. 15. Opening 432 extends along a centrally disposed longitudinal axis DD, that is parallel relative to longitudinal axis CC, as shown in FIG. 17. Longitudinal axis DD is offset a selected distance relative to longitudinal axis CC. In some embodiments, longitudinal axis DD is offset a selected distance from 1 mm to about 4 inches relative to longitudinal axis CC. In some embodiments, interior 434 defines a volume from 2.50 to about 10 gallons. In some embodiments, the volume includes at least 2.50 gallons.

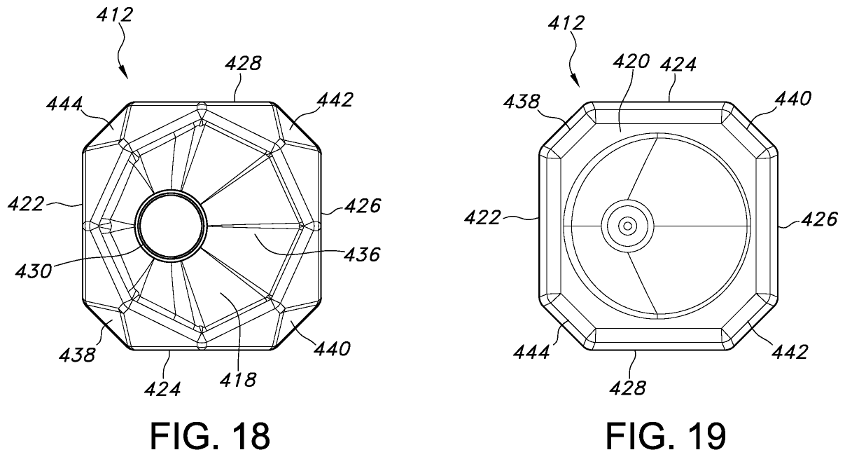

Wall 418 does not include a handle, for example, is handleless. Wall 418 includes a surface that defines a plurality of recesses 436, as shown in FIG. 18. In some embodiments, recesses 436 are strengthening features of container 412. In some embodiments, recesses 436 alternatively include ribs, indents, and/or grooves. In some embodiments, recesses 436 are oriented in a selected pattern. In some embodiments, recesses 436 are aligned with one another perpendicular to longitudinal axis AA. In some embodiments, longitudinal recesses 436 may be disposed at alternate orientations, relative to longitudinal axis AA, for example, transverse, oblique and/or other angular orientations such as acute or obtuse, co-axial and/or may be offset or staggered.

Wall 422 opposes wall 426, and wall 424 opposes wall 428. Body 416 is formed such that inner surfaces of walls 422, 424, 426 and 428 define interior 434, configured for disposal of liquids, food, food preparation and/or beverage products, as described herein. Wall 418 and/or wall 420 extend perpendicular to axis CC.

Sidewalls 422, 424 define a side corner 438, as shown in FIGS. 18 and 19. Sidewalls 424, 426 define a side corner 440, sidewalls 426, 428 define a side corner 442 and sidewalls 422, 428 define a side corner 444. A portion of side corners 438, 440, 442, 444 are angled, and a portion of side corners 438, 440, 442, 444 are straight and are parallel relative to longitudinal axis CC. In some embodiments, a portion of side corners 438, 440, 442, 444 are angled from about 20 to about 60 degrees relative to walls 422, 424, 426, 428. A portion of side corners 438, 440, 442, 444 include recesses 445, as shown in FIG. 12. In some embodiments, recesses 445 alternatively include ribs, indents, and/or grooves.

Sidewall 422 includes a plurality of recesses 446 that are perpendicular relative to longitudinal axis CC, as shown in FIG. 16. Sidewall 424 includes a plurality of recesses 446A, similar to ribs 446 and shown in FIG. 17. Sidewall 426 includes a plurality of recesses 446B, similar to recesses 446. Sidewall 428 includes a plurality of recesses 446C, similar to recesses 446 (not shown). In some embodiments, plurality of recesses 446, 446A, 446B and 446C are configured as gripping surfaces. In some embodiments, plurality of recesses 446, 446A, 446B, 446C are strengthening features of container 412. In some embodiments, plurality of recesses 446, 446A, 446B, 446C alternatively include ribs, indents, and/or grooves. In some embodiments, all or a portion of walls 422, 424, 426 and/or 428 can be smooth, rough, textured, porous, semi-porous, dimpled, knurled, toothed, raised, grooved and/or polished to facilitate gripping. In some embodiments, all or a portion of walls 422, 424, 426 and/or 428 can be textured via a rubber surface.

Box 414 is configured to facilitate carrying of container 412. Box 414 is configured to facilitate stacking of one or more containers 412 for transport and/or display. Box 414 includes a top cover 448, as shown in FIG. 15. Top cover 448 defines an opening 450 configured to provide access to spout 431 of container 412 such that spout 431 is exposed to facilitate dispensing of material within container 412. Box 414 includes a bottom cover 452. Top cover 448 and bottom cover 452 are connected to sidewalls 454, 456, 458, 460. Sidewalls 454, 456, 458, 460 define an interior cavity 462 configured for disposal of container 412.

In some embodiments, container 12 and/or 412 may be fabricated from plastic and formed using injection and compression molding processes. In some embodiments, container 12/412 may be fabricated from polyester (PES), polyethylene (PE), high-density polyethylene (HDPE), polyvinyl chloride (PVC), polyvinylidene chloride (PVDC) (Saran), low-density polyethylene (LDPE), polypropylene (PP), polystyrene (PS), high impact polystyrene (HIPS), polyamides (PA) (Nylons), acrylonitrile butadiene styrene (ABS), polyethylene/acrylonitrile butadiene styrene (PE/ABS), polycarbonate (PC), polycarbonate/acrylonitrile butadiene styrene (PC/ABS), and/or polyurethanes (PU).

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for manufacturing packaging, the method comprising the steps of:
temperature conditioning one or more selected portions of at least one preform; and
blowing and/or stretching the at least one temperature conditioned preform into a blow mold to form a container including an offset neck finish.

2. A method as recited in claim 1, wherein the step of temperature conditioning includes a greater amount of heating applied to the one or more selected portions of the at least one preform relative to at least one remaining portion of the at least one preform.

3. A method as recited in claim 2, wherein the greater amount of heating applied to the one or more selected portions of the at least one preform selectively stretches the one or more selected portions a greater amount relative to the at least one remaining portion.

4. A method as recited in claim 2, wherein the one or more selected portions of the at least one preform is disposed on a first side of the neck finish and the at least one remaining portion is disposed on a second opposite side of the neck finish.

5. A method as recited in claim 1, wherein the step of temperature conditioning includes a greater amount of heating applied to a first selected portion of the at least one preform and a lesser amount of heating and/or cooling applied to a second selected portion of the at least one preform.

6. A method as recited in claim 1, wherein the step of temperature conditioning includes heating the at least one preform to a temperature profile of 90-110 C.

7. A method as recited in claim 1, wherein the step of blowing and/or stretching the at least one temperature conditioned preform includes positioning the at least one temperature conditioned preform in the blow mold so that a centerline of the container is at an angle of 10 or more degrees relative to a vertical axis of the at least one temperature conditioned preform.

8. A method as recited in claim 1, further comprising the step of injecting resin into a mold to form the preform.

9. A method as recited in claim 1, further comprising the step of constructing a box for disposal of the container.

10. A method as recited in claim 1, further comprising the step of releasing the container from the blow mold and transferring the container along a manufacturing line for disposal with a box.

11. A method as recited in claim 1, further comprising the step of palletizing one or more containers in a box for transfer to a filling line.

12. A method as recited in claim 1, wherein the container includes at least one rectangular PET bottle having a 2 to 1 or greater depth to width ratio.

13. A method as recited in claim 1, wherein the container includes the neck finish offset from a central axis of the container a distance selected from a range of 0.25 through 3.00 inches from a front side of the container.

14. A method as recited in claim 1, wherein the steps of the method are performed with a single machine.

15. A method as recited in claim 1, wherein the steps of the method are performed with a first machine and a second machine.

16. A method for manufacturing packaging, the method comprising the steps of:
injecting resin into a mold to form a preform;
temperature conditioning the preform including applying a greater amount of heating to a first selected portion of the preform and applying a lesser amount of heating and/or cooling to a second selected portion of the preform;
blowing and/or stretching the temperature conditioned preform into a blow mold to form a container including an offset neck finish;
releasing the container from the blow mold; and
transferring the container along a manufacturing line for disposal with a box.

17. A packaging comprising:
a container including a handle-less top wall having an offset neck finish defining an opening in communication with an interior of the container, a bottom wall, and a plurality of sidewalls extending between the top wall and the bottom wall; and
a box comprising a top cover, a bottom cover and connected sidewalls defining an inner cavity configured for disposal of the container.

18. A packaging as recited in claim 17, wherein the container is configured to dispense edible oil and the interior defines a volume of at least 2.50 gallons.

19. The packaging as recited in claim 17, wherein the neck finish is offset relative to a central axis of the container a distance selected from a range of 0.25 through 3.00 inches and adjacent a front side of the container.

20. The packaging as recited in claim 17, wherein the container includes a PET bottle and the box includes a corrugated box.
